(19) United States
(12) Patent Application Publication
(10) Pub. No.: US 2010/0315230 A1
(43) Pub. Date: Dec. 16, 2010

(54) DISASTER INFORMATION HANDLING METHOD BASED ON BROADCASTING SYSTEM AND MOBILE TERMINAL SUPPORTING THE SAME

(75) Inventors: Seong Geun KWON, Daegu (KR); Soon Jin KIM, Daegu Metropolitan City (KR); Ki Ryong KWON, Busan (KR); Suk Hwan LEE, Gimhae-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/797,009

(22) Filed: Jun. 9, 2010

(30) Foreign Application Priority Data
Jun. 12, 2009 (KR) 10-2009-0052185

(51) Int. Cl. G08B 21/00

(52) U.S. Cl. 340/540

(57) ABSTRACT

A disaster information handling method based on a broadcasting system and a mobile terminal supporting the same is provided. The method includes receiving a broadcast signal, determining whether disaster information is present in the received broadcast signal, when disaster information is determined to be present in the received broadcast signal, extracting geographic data of a disaster area from the disaster information and extracting location data of a transmitting base station from the received broadcast signal, and performing an alert output operation according to the distance between a site indicated by the geographic data and a site indicated by the location data.

### PRIORITY

This application claims the benefit under 35 U.S.C. §119(a) of a Korean patent application filed on Jun. 12, 2009 in the Korean Intellectual Property Office and assigned Serial No. 10-2009-0052185, the entire disclosure of which is hereby incorporated by reference.

### BACKGROUND OF THE INVENTION

1. Field of the Invention

The present invention relates generally to a mobile terminal More particularly, the present invention relates to a method and mobile terminal that can effectively handle disaster information according to the current location by comparing geographic information contained in a received Digital Multimedia Broadcasting (DMB) signal with location information of a DMB base station transmitting the DMB signal.

2. Description of the Related Art

A mobile terminal supporting mobility may provide various user functions related to mobile communication, gaming, scheduling, and mobile broadcasting such as DMB.

With widespread popularization, mobile terminals have been utilized to distribute disaster information to many users. However, disaster information provided by existing schemes tends to be too uniform and broad. The user of a mobile terminal receiving the disaster information may have difficulty in determining whether the received disaster information is relevant to the user in consideration of the current location. Accordingly, there is a need for a system to enable the user to effectively and accurately obtain disaster information through the mobile terminal.

### SUMMARY OF THE INVENTION

An aspect of the present invention is to address at least the above-mentioned problems and/or disadvantages and to provide at least the advantages described below. Accordingly, an aspect of the present invention is to provide a method and mobile terminal that enable the user to accurately obtain disaster information through a broadcasting network and to effectively cope with the disaster according to the current location by comparing the geographic location indicated by the disaster information with the current location.

In accordance with an aspect of the present invention, a method for disaster information handling based on a broadcasting system is provided. The method includes receiving a broadcast signal, determining whether disaster information is present in the received broadcast signal, extracting, when disaster information is determined to be present in the received broadcast signal, geographic data of a disaster area from the disaster information, and extracting location data of a transmitting base station from the received broadcast signal; and performing an alert output operation according to the distance between a site indicated by the geographic data and a site indicated by the location data.

In accordance with another aspect of the present invention, a mobile terminal supporting disaster information notification based on a broadcasting system is provided. The mobile terminal includes a broadcast reception module for receiving a broadcast signal containing disaster information location data, the disaster information including geographic data of a disaster area and the location data including a location of a transmitting base station a control unit for extracting the geographic data from the disaster information, and determining an alert output operation according to the distance between a first site indicated by the geographic data and a second site indicated by the location data; and an output unit performing the determined alert output operation.

According to aspects of the present invention, the method and mobile terminal enable the user to rapidly cope with the disaster when obtained disaster information is relevant to the current location, and discourage the user from conducting an unnecessary action when obtained disaster information is not related to the current location. Hence, it is possible to provide disaster information in a flexible and reliable way.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a Digital Multimedia Broadcasting (DMB)-based system for providing disaster information according to an exemplary embodiment of the present invention;

FIG. 2 illustrates an arrangement of DMB base stations in the system of FIG. 1 according to an exemplary embodiment of the present invention;

FIG. 3 illustrates data structures for transmitting disaster information according to an exemplary embodiment of the present invention;

FIG. 4 illustrates data structures for transmitting location information of a DMB base station according to an exemplary embodiment of the present invention;

FIG. 5 is a block diagram of a mobile terminal according to an exemplary embodiment of the present invention; and

FIG. 6 is a flowchart illustrating a disaster information handling method based on DMB according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and the spirit of the invention. Also descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the description, the broadcasting technology is based on Digital Multimedia Broadcasting (DMB). However, exemplary embodiments of the present invention are not limited thereto. Disaster information may be distributed through various broadcasting technologies including DMB and Digital Video Broadcasting—Handheld (DVB-H).

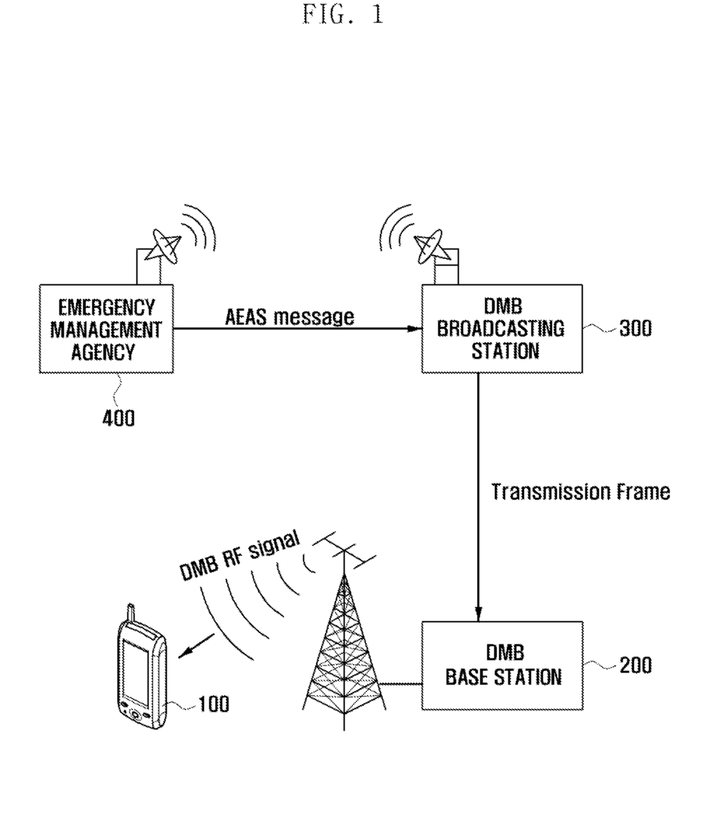

FIG. 1 illustrates a DMB-based system for providing disaster information according to an exemplary embodiment of the present invention.

Referring to FIG. 1, the disaster information providing system may include an emergency management agency 400, a DMB broadcasting station 300, a DMB base station 200, and a mobile terminal 100. The disaster information providing system may also include other elements not shown here, and the shown elements may be plural in number. For example, the disaster information providing system may include several DMB base stations 200.

In the disaster information providing system, the emergency management agency 400 collects disaster information and composes an Automatic Emergency Alert Message Service (AEAS) message containing the collected disaster information and sends the composed AEAS message to the DMB broadcasting station 300. The DMB broadcasting station 300 converts the AEAS message into transmission frames through segmentation and sends the transmission frames to the DMB base station 200. The DMB base station 200 generates a DMB Radio Frequency (RF) signal of a given frequency carrying the transmission frames and broadcasts the DMB RF signal to the mobile terminal 100. In this process, the AEAS message may contain geographic data regarding the disaster area specified by the emergency management agency 400. The transmission frame may contain location data of the DMB base station 200. The mobile terminal 100 receiving a DMB signal carrying disaster information may determine the relevancy of the disaster information with respect to the current location by comparing the geographic data of the disaster area with the location data of the DMB base station 200, and display alert messages of multiple forms and types on the screen according to the determination.

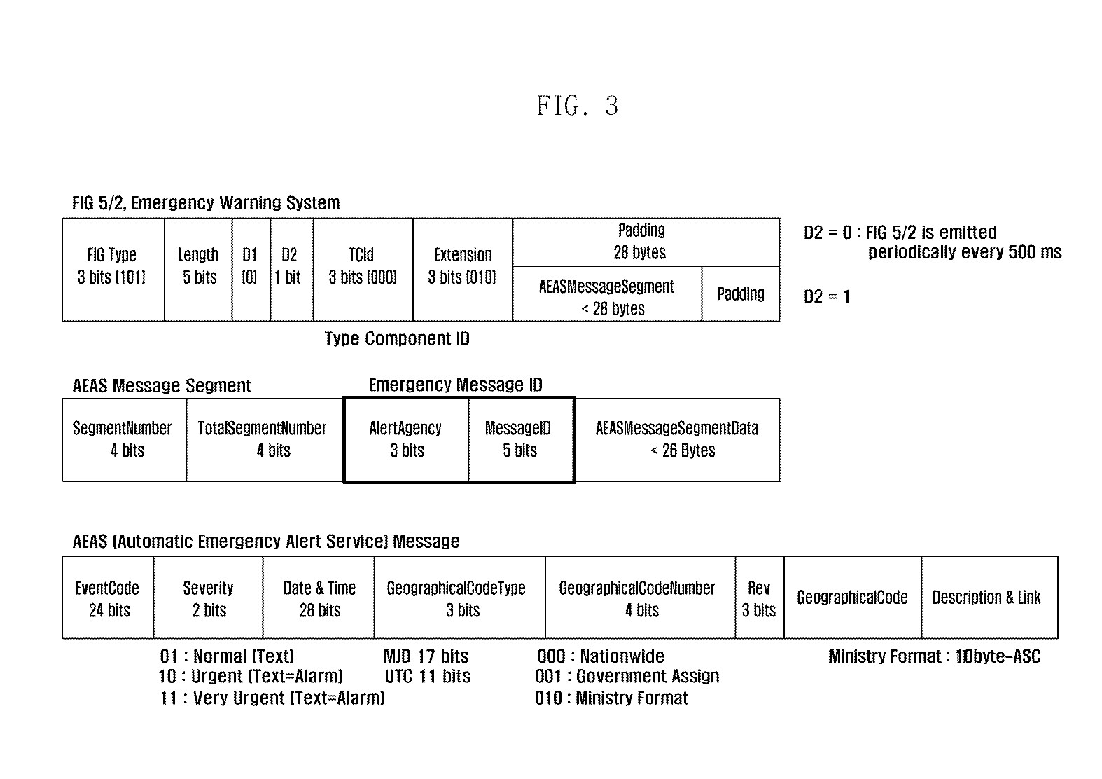

The emergency management agency 400 is an organization or body providing disaster information containing geographic data, and may be a nationwide, provincial, or local organization. The emergency management agency 400 collects disaster information regarding various environmental conditions. These environmental conditions may include natural disasters (such as heavy rain, storms, earthquakes, volcanic eruptions, and dust storms), and man-made disasters (such as forest fires, traffic accidents, and collapsed buildings). The disaster information generated by the emergency management agency 400 may include geographic data indicating the geographic region at which the disaster has occurred. The geographic data may take various forms. For example, the geographic data may be code values assigned to administrative or geographic districts (cities, provinces, counties) of a state or country. When the number of districts is 1000, ten bits are sufficient to uniquely identify each district. The emergency management agency 400 collects information on disasters in real time, and may compose an AEAS message containing a code value for geographic data and a description of a particular disaster. The emergency management agency 400 may also add latitude and longitude data matching the geographic data to the AEAS message. The AEAS message is described in detail later in connection with FIG. 3.

Upon reception of an AEAS message, the DMB broadcasting station 300 converts the AEAS message, together with other information, into transmission frames according to the DMB standard, and sends the transmission frames to the DMB base station 200. The DMB broadcasting station 300 may produce or purchase various broadcast programs related to entertainment, news, and daily life. The DMB broadcasting station 300 may convert a broadcast program into transmission frames according to the DMB standard, and send the transmission frames to the DMB base station 200. The DMB broadcasting station 300 may operate in program production mode or in program relay mode. The DMB broadcasting station 300 normally sends transmission frames containing program content to the DMB base station 200. When an AEAS message is received from the emergency management agency 400, the DMB broadcasting station 300 sends transmission frames containing both program content and the AEAS message to the DMB base station 200. A transmission frame may have a value indicating presence or absence of disaster information.

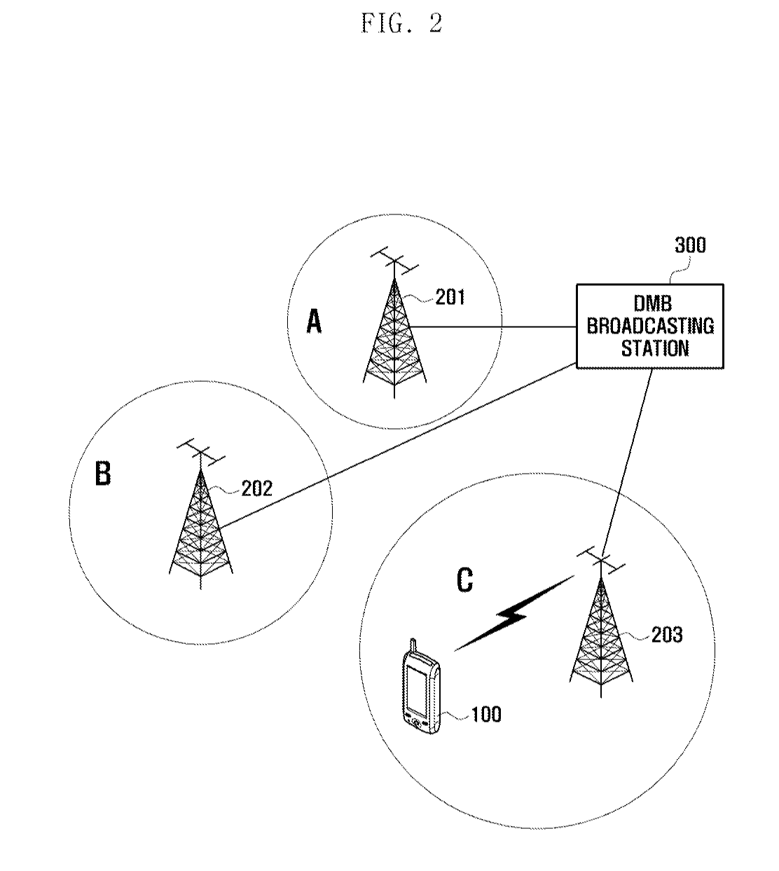

FIG. 2 illustrates an arrangement of DMB base stations in the system of FIG. 1 according to an exemplary embodiment of the present invention.

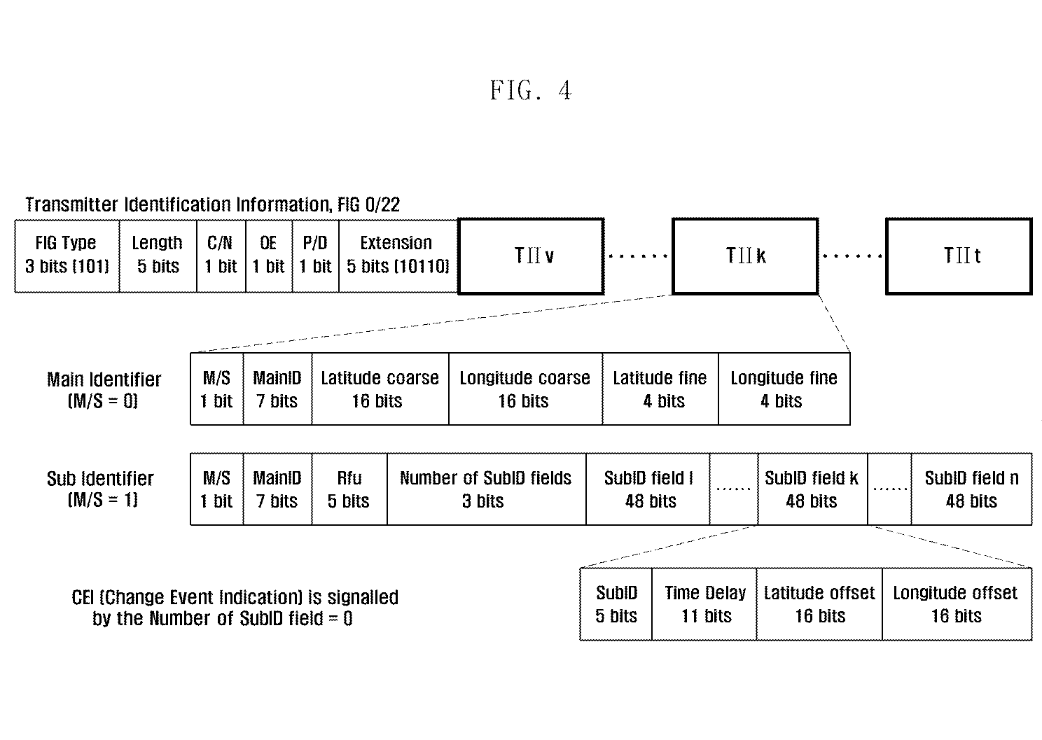

Referring to FIG. 2, the DMB base station 200 receives a transmission frame, converts the transmission frame into a DMB signal, and broadcasts the DMB signal over the air to the mobile terminal 100. The coverage area of a DMB base station is limited due to transmission power and other factors, and multiple DMB base stations may be installed at regular intervals. The DMB broadcasting station 300 may send transmission frames to a first DMB base station 201 having a coverage area A, a second DMB base station 202 having a coverage area B, and a third DMB base station 203 having a coverage area C. Although the coverage areas of the three DMB base stations 201, 202 and 203 do not overlap in FIG. 2, the coverage areas thereof may overlap in part for continuous DMB reception. Each DMB base station 201, 202, or 203 may have unique location information in the form of latitude and longitude. When the mobile terminal 100 is within the coverage area of the third DMB base station 203, the mobile terminal 100 may receive a DMB signal from the third DMB base station 203. The received DMB signal may contain the latitude and longitude data indicating the location of the third DMB base station 203. Exemplary embodiments of the present invention are not limited by the three DMB base stations shown above. Many DMB base stations may be installed at regular intervals to cover a country-wide service area. Each DMB base station may broadcast a DMB signal containing specific location data in the form of latitude and longitude. Location data contained in a DMB signal is described in detail later in connection with FIG. 4.

The mobile terminal 100 may activate the DMB module according to a user request, and receive a DMB signal from the DMB base station 200. The mobile terminal 100 may check for the presence of disaster information in the received DMB signal. When disaster information is present, the mobile terminal 100 may extract the disaster information and obtain geographic data from the disaster information. The mobile terminal 100 may also extract location data of the DMB base station 200 from the received DMB signal, and compare the location data with the geographic data. When the geographic data corresponds to code values assigned to administrative or other districts in the country, for adequate comparison between location data and geographic data, each code value acting as geographic data may have to be matched with the latitude and longitude of the corresponding district. Hence, the mobile terminal 100 may pre-store latitudes and longitudes of the administrative districts corresponding to code values. Alternatively, when the geographic data is initially designed in terms of latitude and longitude, the mobile terminal 100 does not have to perform code-to-latitude and longitude mapping.

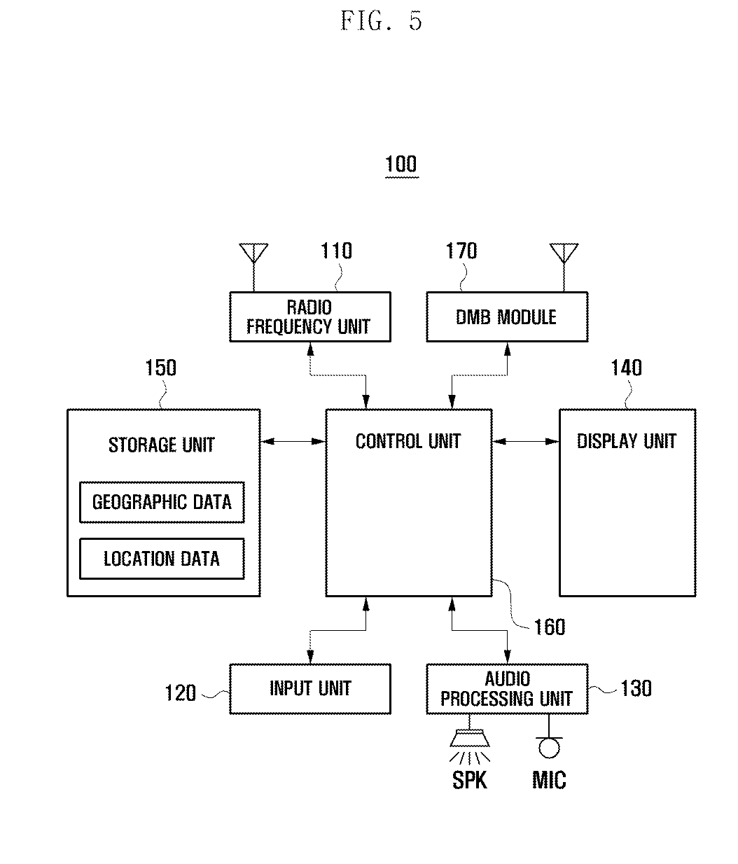

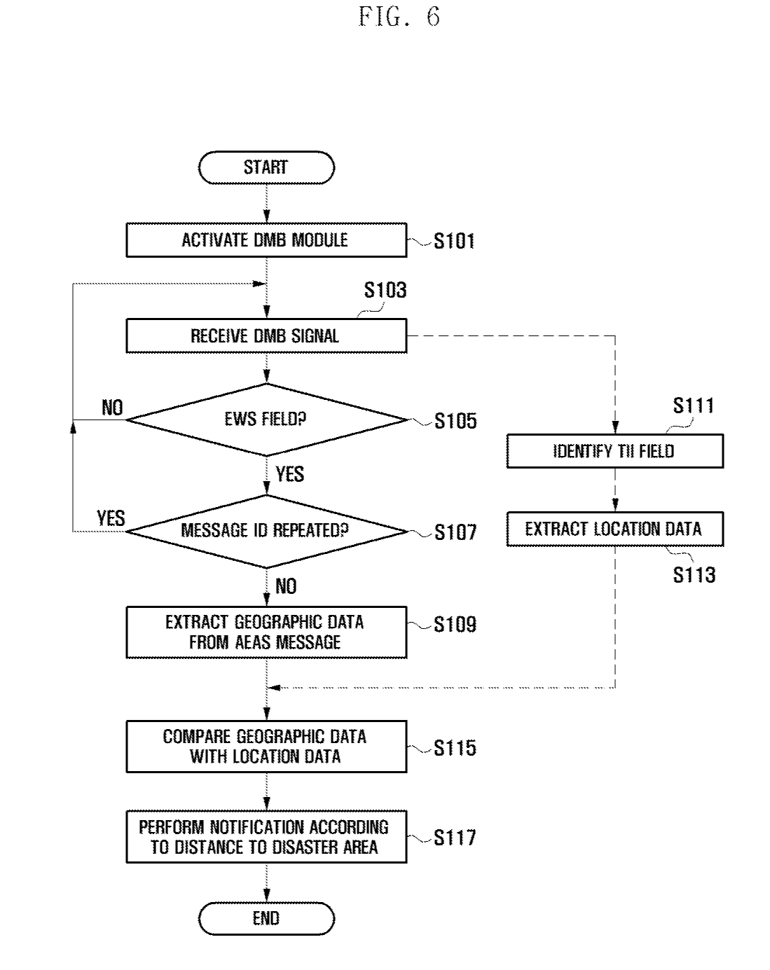

The mobile terminal 100 may compare the geographic data and the location data to assess the relevance of the disaster information. When the distance between the area indicated by the geographic data and the area indicated by the location data is less than a reference distance, the mobile terminal 100 may regard the disaster information as information that is highly valuable information to the user. When the distance between the area indicated by the geographic data and the area indicated by the location data is greater than the reference distance, the mobile terminal 100 may regard the disaster information as information to be known to the user or as information that can be disregarded according to the distance. When the disaster information can be disregarded, the mobile terminal 100 may not output the disaster information to the screen, or may output the disaster information in a less intrusive fashion. The configuration and operation of the mobile terminal 100 are described in detail in connection with FIGS. 5 and 6.

FIG. 3 illustrates data structures for transmitting disaster information according to an exemplary embodiment of the present invention.

Referring to FIG. 3, the disaster information is encoded using the Fast Information Group (FIG) Type 5 Extension 2 (FIG 5/2) for Emergency Warning System (EWS) format. The FIG Type 5 Extension 2 includes the following fields: FIG Type, Length, D1, D2, TCId, Extension, Padding, AEASMessageSegment, and Padding.

The FIG Type field indicates the type of FIG, is 3-bits wide, and may be set to 101 when disaster information is present. The Length field indicates the length of the FIG data field. The D1 field is 1-bit wide and is reserved for future use. The D2 field is 1-bit wide, and is set to ‘1’ when disaster information is present. The D2 field set to ‘0’ may indicate periodic transmission of padding data at a period of 500 ms. The TCId field (Type Component Id) is 3-bits wide, and is set to ‘000’ for a common service when disaster information is present. The Extension field is 3-bits wide, and may be set to ‘010’ when extension data is present. The AEASMessageSegment field is less than 28 bytes in length, and stores disaster information (a segment of an AEAS message). The Padding field may be used for padding data.

An AEAS message segment is stored for transmission in the AEASmessageSegment field, and may include the following fields: SegmentNumber, TotalSegmentNumber, AlertAgency, MessageID, and AEASMessageSegmentData. The SegmentNumber field is 4-bits wide, and indicates the sequence number of the current AEAS message segment. The TotalSegmentNumber field is 4-bits wide, and indicates the total number of segments constituting the current AEAS message. The AlertAgency and MessageID fields indicate the identifier of the AEAS message (Emergency Message ID). The AlertAgency field is 3-bits wide and indicates the code value assigned to the organization generating the AEAS message. The MessageID field is 5-bits wide and indicates the identifier of the AEAS message. The Emergency Message ID is used to uniquely identify individual AEAS messages in the country. The receiver may use the Emergency Message ID to assemble multiple message segments into a whole AEAS message, and to avoid repeated message reception. The AEASMessageSegmentData field is less than 26 bytes in length, and stores the content of the AEAS message segment.

The AEAS Message is sent from the emergency management agency to the DMB broadcasting station 300, and may include the fields EventCode, Severity, Date & Time, GeographicalCodeType, GeographicalCodeNumber, Rev, GeographicalCode, and Description & Link. The EventCode field is 24-bits wide, and indicates one of disaster events specified by the emergency management agency 400. The Severity field is 2-bits wide and may have three levels of severity: value ‘01’ indicates a severity level “normal” and textual display for notification; value ‘10’ indicates a severity level “urgent” and textual display and alarm output for notification; and value ‘11’ indicates a severity level “very urgent” and textual display and alarm output for notification. The Date & Time field is 28-bits wide. 17 bits of the Date & Time field are allocated for Modified Julian Date (MJD) and 11 bits are allocated for Coordinated Universal Time (UTC). The GeographicalCodeType field is 3-bits wide, and indicates the code format for geographic districts. The value ‘000’ indicates “Nationwide”, the value ‘001’ indicates “Government Assign”, and the value ‘010’ indicates “Ministry Format”. The GeographicalCodeNumber field is 4-bits wide, and indicates the number of geographical code values. The Rev field is 3-bits wide and is reserved for future use. The GeographicalCode field stores geographical code values as 10-byte ASCII characters when the GeographicalCodeType field is set to ‘010’ (“Ministry Format”). The Description & Link field is used for a supplementary description or link.

FIG. 4 illustrates data structures for conveying location information of a DMB base station to a mobile terminal according to the DMB standard and according to an exemplary embodiment of the present invention.

Referring to FIG. 4, a DMB base station may broadcast various data coming from the DMB broadcasting station to mobile terminals. In this process, the DMB base station may send its location information (coded in the format of Transmitter Identification Information (TII), FIG 0/22) to mobile terminals. The DMB base station may broadcast a DMB signal carrying a transmission frame with TH. The FIG Type 0 Extension 22 includes the following fields: FIG Type, Length, C/N, OE, P/D, Extension, and TH. The FIG Type field indicates the type of FIG and is 3-bits wide. The Length field is 5-bits wide, and indicates the length of the FIG data field. The C/N (Current/Next) field may indicate that the type 0 field carries information for a database. The Other Ensemble (OE) field indicates whether the information is related to this or another ensemble. The P/D field indicates program services or data services. Multiple TII fields may be included. The C/N, OE and P/D fields may characterize the FIG type 0 data, and may have values defined by the relevant regulations of the emergency management agency. Values of these fields may be interpreted differently depending upon country or district.

As shown in FIG. 4, the TII k field (one of multiple TII fields) may be related to a Main Identifier or a Sub Identifier. When the M/S field (1-bit wide) is set to ‘0’, the TII k field is related to a Main Identifier. When the M/S field (1-bit wide) is set to ‘1’, the TII k field is related to a Sub Identifier and refers to the Main Identifier.

The Main Identifier may include an M/S field of 1 bit (described above), a MainId field of 7 bits, a Latitude coarse field of 16 bits, a Longitude coarse field of 16 bits, a Latitude fine field of 4 bits, and a Longitude fine field of 4 bits. The Latitude coarse field, Longitude coarse field, Latitude fine field, and Longitude fine field may be used to specify the location of a DMB base station. The Latitude coarse field and Longitude coarse field may specify the coarse latitude and the coarse longitude, respectively, The Latitude fine field and Longitude fine field may specify the latitude offset and the longitude offset, respectively.

The Sub Identifier may include an M/S field of 1 bit, a MainId field of 7 bits, an Rfu field of 5 bits, a Number-of-SubId-fields field of 3 bits for indicating the number of following SubId fields, and one or more SubId fields each having 48 bits. As shown in FIG. 4, the SubId field k may include a SubId subfield of 5 bits, a Time Delay subfield of 11 bits, a Latitude offset subfield of 16 bits, and a Longitude offset subfield of 16 bits. The SubId fields may provide additional information regarding the DMB base station, such as latitude offsets, longitude offsets, and time delays of a transmitted signal. As described above, the Sub Identifier may be present or absent according to the value of the M/S field. It may be sufficient for the mobile terminal to determine the location of a DMB base station using the latitude and longitude given in the Main Identifier.

The DMB broadcasting station receives an AEAS message containing disaster information from the emergency management agency, generates transmission frames containing the AEAS message, and sends the transmission frames to the DMB base station. The DMB base station converts the transmission frames into a DMB signal containing location information thereof, and broadcasts the DMB signal to the mobile terminal. Upon reception of a DMB signal carrying transmission frames from the DMB base station, the mobile terminal may detect a FIG 0/22 TII field for location data of the DMB base station and detect a FIG 5/2 EWS field for geographic data on the disaster area. Next, a description is given of the operation of the mobile terminal in connection with FIG. 5.

FIG. 5 is a block diagram of the mobile terminal 100 according to an exemplary embodiment of the present invention.

Referring to FIG. 5, the mobile terminal 100 may include a radio frequency unit 110, an input unit 120, an audio processing unit 130, a display unit 140, a storage unit 150, a DMB module 170 for broadcast reception, and a control unit 160. The display unit 140 and audio processing unit 130 may constitute an output unit that produces an audiovisual alert according to the distance between the site indicated by the geographic data and the site indicated by the location data. A vibration device may be added to the output unit for producing a vibration as an alert.

The mobile terminal 100 having the above configuration receives a DMB signal carrying a transmission frame through the DMB module 170, and checks whether an AEAS message conveying disaster information is present in the transmission frame. When an AEAS message is present in the transmission frame, the mobile terminal 100 extracts geographic data such as a district code or latitude and longitude from the AEAS message, and stores the extracted geographic data. The mobile terminal 100 extracts location data of the transmitting DMB base station (FIG 0/22 TII field) from the transmission frame. The mobile terminal 100 estimates the distance between the site indicated by the geographic data and the site indicated by the location data, and outputs a disaster alert corresponding to the distance through the display unit 140.

The radio frequency unit 110 sends and receives a signal related to a voice call, a Short Message Service (SMS) message, a Multimedia Message Service (MMS) service, and data communication under the control of the control unit 160. The radio frequency unit 110 may convert voice, audio, and control data into a radio signal and transmit the radio signal, and may receive a radio signal and convert the radio signal into voice, audio and control data for output. To achieve this, the radio frequency unit 110 may include a transceiver that upconverts the frequency of a signal to be transmitted and amplifies the signal, and low-noise amplifies a received signal and downconverts the frequency of the received signal. The radio frequency unit 110 is included in the mobile terminal 100 when the mobile terminal 100 supports mobile communication, and may be omitted according to design.

The input unit 120 includes a plurality of alphanumeric and function keys for inputting alphanumeric information and for setting various functions. The function keys may include direction, side, and shortcut keys associated with corresponding functions. The input unit 120 transmits key signals from the user for setting and controlling the mobile terminal to the control unit 160. The input unit 120 may be realized using a keypad including multiple keys, such as a qwerty keypad, 3*4 keypad or 4*3 keypad. The input unit 120 transmits an input signal corresponding to a key entered by the user to the control unit 160, and may generate various input signals according to running application programs. For example, the input unit 120 may generate an input signal for activating the DMB module 170, and generate an input signal for viewing disaster information when a disaster alert is displayed on the display unit 140.

The audio processing unit 130 includes a speaker for reproducing audio data related to a call, and a microphone for collecting a voice or audio signal from the user making a call. The audio processing unit 130 may produce different alarm sounds according to the relatedness between geographic data for a disaster area and location data of a DMB base station. For example, when the disaster area indicated by the disaster information encloses or is very close to the location of a transmitting DMB base station (a current location of the mobile terminal), the audio processing unit 130 may output a preset alarm sound or notification that is readily recognizable by the user. When the distance between the disaster area and the current location is less than a reference distance, the audio processing unit 130 may output a notification indicating occurrence of a disaster (urgent message or urgent priority) at a specific area. When the distance between the disaster area and the current location is greater than the reference distance, the audio processing unit 130 may ignore the disaster information or output a passing sound notification. Alarm processing of the audio processing unit 130 may be varied according to the design or functionality of the mobile terminal 100. The reference distance to the disaster area may be varied according to the terminal design, the regulation provided by the emergency management agency, and types of disasters. For example, the reference distance for a small area disaster such as a small forest fire or a traffic accident may be less than that for a wide area disaster such as an earthquake or volcanic eruption.

The display unit 140 displays various menus of the mobile terminal 100, information input by the user, and information to be provided to the user. The display unit 140 may display various screens related to the operation of the mobile terminal 100 such as an idle screen, menu screen, message composition screen, and call handling screen. The display unit 140 may output at least one of a text string, an icon, and an image corresponding to disaster information. The AEAS message may contain a text string given by the emergency management agency, and the display unit 140 may output the text string extracted from the AEAS message under the control of the control unit 160. While playing back a broadcast program after activation of the DMB module 170, the display unit 140 may output the text string as an overlay on the broadcast program.

The display unit 140 may output at least one of a text string, an icon, and an image according to the notification level related to the distance to the disaster area indicated by the AEAS message. For example, when the distance to the disaster area is less than a first reference distance, the display unit 140 may output a text string for evacuation (very urgent alert message or very urgent priority), such as “evacuate to safe place”, or output a preset icon or image in a full screen format for notifying immediate disaster exposure. When the distance to the disaster area is greater than or equal to the first reference distance and less than a second reference distance, the display unit 140 may output at least one of a text string, an icon, and an image for indicating a disaster alert. When the distance to the disaster area is greater than the second reference distance, the display unit 140 may output a preset icon for indicating reception of disaster information. Outputting a text string, icon, and image for a disaster alert may be changed according to the terminal design or user settings.

The display unit 140 may be realized using Liquid Crystal Display (LCD) devices or Organic Light Emitting Diodes (OLED). When the display unit 140 includes a touch sensor at the front or side and acts as a touch screen, the display unit 140 may act as an input unit. To act as an input unit, the display unit 140 may display an image containing various menu maps and key maps, the touch sensor may detect a touch on the displayed image and send the touched location to the control unit 160, which then may identify a function mapped to the touched location and invoke the identified function. For example, when the display unit 140 displays a text string, icon, or image for disaster notification, the user may generate an input signal for viewing the content of the text string by touching the icon or image.

The storage unit 150 may store application programs related to exemplary embodiments of the present invention, application programs for playing back various media files, and key maps or menu maps for the touch screen capability. The key maps may correspond to various keypads, including a 3*4 keypad and a qwerty keypad, and may include a control key map for controlling execution of an activated application program. The menu maps may include a menu map for controlling execution of an activated application program, and a menu map related to the menus of the mobile terminal 100. The storage unit 150 may store an application program for handling disaster information. The storage unit 150 may include a program area and a data area.

The program area may store an Operating System (OS) for booting and operating the mobile terminal 100, application programs for reproduction of various files, application programs for call-related functions, a browser for accessing an Internet web server, application programs for playback of MP3 data, and application programs for viewing photographs, still images and moving images. In particular, the program area may store an application program for operating the DMB module and an application program for handling disaster information.

The application program for operating the DMB module may include a routine for activating the DMB module in response to an input signal, a routine for extracting a transmission frame from a DMB signal received by the DMB module, a routine for selecting a program channel in the transmission frame according to channel setting information of the user, and a routine for sending audio data and video data of the program channel respectively to the display unit and audio processing unit. The application program for operating the DMB module may further include routines for channel scanning and making a preferred channel list.

The application program for handling disaster information may be invoked by the control unit 160 after activation of the DMB module, may extract information on a disaster and location information of the DMB base station from a DMB signal broadcast by the DMB base station, and may perform a notification operation according to the distance to the disaster area (here, the current location is given by the location of the transmitting DMB base station). The application program for handling disaster information may include a routine for checking the presence of disaster information (an AEAS message) in a received DMB signal, a routine for extracting, when an AEAS message is present, a description of the disaster such as type and severity, a routine for extracting geographic data of the disaster area, a routine for identifying the location of the DMB base station, a routine for estimating the distance between the disaster area and the location of the DMB base station, a routine for outputting a preset alarm according to the estimated distance, and a routine for outputting the disaster description including type, severity, and other information.

The data area may store data generated by the utilization of the mobile terminal 100, and various contents. When the display unit has a touch screen capability, the data area may store coordinates of a touched location. The data area may temporarily store location information of a DMB base station, broadcast program data, disaster information, extracted from a received DMB signal. The data area may store a table of latitudes and longitudes matched with district codes assigned to possible disaster areas. The latitude-longitude table may be used when geographic data is not in the form of latitude and longitude. After executing the application program for handling disaster information, the control unit 160 may use the latitude-longitude table to identify the latitude and longitude of the disaster area, and compare the latitude and longitude of the disaster area with those of the transmitting DMB base station.

The control unit 160 may control power supplied to each block of the mobile terminal 100 for initialization, and control signals exchanged between the blocks to alert arrival of disaster information. In particular, the control unit 160 may control an operation to receive a DMB signal broadcast by a DMB base station, extract disaster information and location information of the DMB base station from the received DMB signal, estimate the distance between the site indicated by the disaster information and the site indicated by the location information, and notify the user of the disaster according to the estimated distance. Next, a description is given of a disaster information handling method in connection with the operation of the control unit 160.

FIG. 6 is a flowchart illustrating a disaster information handling method based on DMB according to an exemplary embodiment of the present invention.

Referring to FIG. 6, the mobile terminal activates the DMB module in response to an input signal from the input unit in step S101. The input unit may include keys and menus for activating the DMB module. The mobile terminal controls the DMB module to receive a DMB signal (or a broadcast stream) in step S103. The received DMB signal is demodulated and decoded into a transmission frame, and the transmission frame is sent to the control unit for further processing. The mobile terminal determines whether an EWS field is present in the transmission frame in step S105. A DMB signal may carry a transmission frame with the EWS field containing an AEAS message segment, which conveys disaster information provided by the emergency management agency. A distinct header is prefixed to the EWS field. The mobile terminal may determine whether disaster information is present in the transmission frame by checking the header of the EWS field.

When an EWS field is not present in the transmission frame, the mobile terminal returns to step S103 for continued broadcast reception. At step S103, broadcast program data of a selected channel may be extracted from the received DMB signal and sent to the display unit and audio processing unit. Hence, the user may view a desired broadcast program.

When an EWS field is present in the transmission frame, the mobile terminal determines whether the AEAS message in the EWS field is a repeated message in step S107. To achieve this, the mobile terminal may compare the message ID of the current AEAS message with that of the previous AEAS message. The mobile terminal may temporarily store received message IDs. When the message ID of the AEAS message is the same as that of the previous AEAS message, the mobile terminal returns to step S103 for continued broadcast reception.

When the AEAS message is not a repeated message (i.e., the AEAS message is a new message), the mobile terminal extracts various data regarding a disaster from the AEAS message in step S109. The mobile terminal may obtain the disaster type and severity, a supplementary description, and geographic data of the disaster area from the AEAS message.

Meanwhile the mobile terminal identifies the TTI field in the transmission frame in step S111 optionally after operating step S103. A DMB transmission frame may contain a TTI field indicating the location of the transmitting DMB base station. The mobile terminal extracts the location data of the DMB base station from the TTI field in step S113. Hence, the mobile terminal may be aware of the current approximate location. Step S111 (TTI field identification) and step S113 (location data extraction) may be performed only when an EWS field is detected at step S105. Step S111 and step S113 need not be performed when an EWS field is not detected at step S105.

The mobile terminal estimates the distance between the disaster area indicated by the geographic data and the site indicated by the location data in step S115. The mobile terminal performs disaster notification through at least one of the display unit and audio processing unit according to the estimated distance in step S117. A vibration motor may also be used for notification according to design. For example, when the distance to the disaster area is less than a first reference distance, the mobile terminal may notify the user of immediate disaster exposure by outputting an indication “evacuate to safe place” utilizing at least one of a text string, image, icon, vibration, and sound alarm. The notification may interrupt broadcast viewing. When the distance to the disaster area is greater than or equal to the first reference distance and less than a second reference distance, the mobile terminal may output at least one of a text string, an icon, and an image for indicating occurrence of a disaster alert (urgent alert message or urgent alert priority) at a specific area. When the distance to the disaster area is greater than the second reference distance, the mobile terminal may output a preset icon indicating reception of disaster information and save the disaster information for future reference. In this case, the icon indicating reception of disaster information may be displayed at a given zone so that broadcast viewing is not interrupted. In the case where map data is stored in the storage unit, the mobile terminal may mark the disaster area and the current location on the on-screen map when disaster information is received. To achieve this, the mobile terminal may store map data, geographic data, location data, and mappings therebetween.

As apparent from the above description, the disaster information handling method and the mobile terminal compare the geographic data in the AEAS message provided by the emergency management agency with the location data of the transmitting DMB base station, estimate the impact of the disaster on the user on the basis of the distance to the disaster area, and notify the user through various means according to the estimated impact. The user may take immediate action to evacuate the disaster area when the disaster area is too close to the current location; and the user may take no action when the disaster area is very far from the current location. Hence, it is possible to increase the reliability of disaster notification based on a broadcasting network.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A disaster information handling method based on a broadcasting system, the method comprising:
receiving a broadcast signal;
determining whether disaster information is present in the received broadcast signal;
when disaster information is determined to be present in the received broadcast signal, extracting geographic data of a disaster area from the disaster information, and extracting location data of a transmitting base station from the received broadcast signal; and
performing an alert output operation according to the distance between a site indicated by the geographic data and a site indicated by the location data.

2. The method of claim 1, wherein the performing of the alert output operation comprises:
outputting, when the distance between the sites is less than a first reference distance, at least one of a text string, image, icon, vibration, and sound alarm indicating very urgent priority;
outputting, when the distance between the sites is greater than or equal to the first reference distance and less than a second reference distance, at least one of a text string, image, icon, vibration, and sound alarm indicating urgent priority; and
preventing, when the distance between the sites is greater than the second reference distance, output of a normal priority notification related to disaster information reception.

3. The method of claim 1, further comprising:
outputting audio data and video data of a broadcast program selected by a channel setting from the received broadcast signal to at least one of a display unit and an audio processing unit.

4. The method of claim 3, wherein the performing of the alert output operation comprises outputting at least one of a text string, image, and icon for disaster notification in an overlay on the display unit displaying the video data.

5. The method of claim 1, further comprising:
producing, when the geographic data is given by a code value assigned to an administrative district, the latitude and longitude corresponding to the administrative district to compare the geographic data with the location data given by the latitude and longitude.

6. The method of claim 1, wherein the performing of the alert output operation comprises:
marking the site indicated by the geographic data and the site indicated by the location data on a pre-stored map; and
displaying the map on a display unit.

7. The method of claim 1, further comprising:
checking, when disaster information is present in the received broadcast signal, the message ID of the disaster information; and
discarding, when the message ID is a repeated message ID, the disaster information.

8. The method of claim 1, wherein the performing of the alert output operation comprises outputting at least one of the type, severity, and textual description of a disaster extracted from the disaster information to a display unit.

9. A mobile terminal supporting disaster information notification based on a broadcasting system, the mobile terminal comprising:
a broadcast reception module for receiving a broadcast signal containing disaster information and location data, the disaster information including geographic data of a disaster area and the location data including a location of a transmitting base station;
a control unit for extracting the geographic data from the disaster information, and for determining an alert output operation according to the distance between a first site indicated by the geographic data and a second site indicated by the location data; and
an output unit performing the determined alert output operation.

10. The mobile terminal of claim 9, wherein when the distance between the first and second sites is less than a first reference distance, the output unit outputs at least one of a text string, image, icon, vibration and sound alarm indicating very urgent priority; when the distance between the first and second sites is greater than or equal to the first reference distance and less than a second reference distance, the output unit outputs at least one of a text string, image, icon, vibration, and sound alarm indicating urgent priority, and when the distance between the first and second sites is greater than the second reference distance, the output unit prevents output of a normal priority notification related to disaster information reception.

11. The mobile terminal of claim 9, wherein the output unit comprises a display unit for displaying video data of a broadcast program selected by a channel setting from the received broadcast signal.

12. The mobile terminal of claim 11, wherein the output unit outputs at least one of a text string, image, and icon for disaster notification in an overlay on the display unit displaying the video data.

13. The mobile terminal of claim 9, further comprising a storage unit for storing at least one of latitude-longitude data corresponding to administrative districts for converting geographic data given by a code value assigned to an administrative district into the latitude and longitude, and map data for marking the site indicated by the geographic data and the site indicated by the location data.

14. The mobile terminal of claim 13, wherein the output unit comprises a display unit for displaying a map marking the site indicated by the geographic data and the site indicated by the location data.

15. The mobile terminal of claim 13, wherein the output unit comprises a display unit for outputting at least one of the type, severity, and textual description of a disaster extracted from the disaster information.

16. The mobile terminal of claim 9, wherein, when the distance between the first and second sites is less than or equal to a first distance, the output unit outputs a very urgent alert message interrupting broadcast viewing;
wherein, when the distance between the first and second sites is greater than the first distance and less than or equal to a second distance, the output unit outputs an urgent alert message; and
wherein, when the distance between the first and second sites is greater than the second distance, the output unit outputs a normal alert message without interrupting broadcast viewing.

17. A disaster information notification system comprising:
a Digital Multimedia Broadcasting (DMB) broadcasting station for receiving an Automatic Emergency Alert Message Service (AEAS) message including disaster information, and for generating transmission frames including the disaster information;
a plurality of DMB base stations for receiving the transmission frames from the DMB broadcasting station and for broadcasting a DMB Radio Frequency (RF) signal including the transmission frames and location information of a corresponding one of the DMB base stations; and
a plurality of mobile terminals for receiving the DMB Radio Frequency signal from at least one of the plurality of DMB base stations and for generating an alert message based on the disaster information and the location information.

18. The system of claim 17, wherein the disaster information includes geographic information identifying a location of the disaster.

19. The system of claim 18, wherein a mobile terminal receiving the DMB RF signal determines whether the received disaster information included in the received DMB RF signal is new disaster information, and if the mobile terminal determines that the received disaster information is new, the mobile terminal generates an alert message based on a distance between a first site corresponding to the location of the disaster and a second site corresponding to a location of the DMB base station from which the mobile terminal received the DMB RF signal.

20. The system of claim 19, wherein, when the distance between the first and second sites is less than or equal to a first distance, the mobile terminal outputs a very urgent alert message interrupting broadcast viewing;
wherein, when the distance between the first and second sites is greater than the first distance and less than or equal to a second distance, the mobile terminal outputs an urgent alert message; and
wherein, when the distance between the first and second sites is greater than the second distance, the mobile terminal outputs a normal alert message without interrupting broadcast viewing.
